(19) United States
(12) Patent Application Publication
(10) Pub. No.: US 2018/0123404 A1
(43) Pub. Date: May 3, 2018

(54) ELECTRICAL MACHINE

(71) Applicant: Magna Powertrain GmbH & Co KG, Lannach (AT)

(72) Inventor: Craig VITSAXAKIS, Traiskirchen (AT)

(21) Appl. No.: 15/567,658

(22) PCT Filed: Mar. 15, 2016
(86) PCT No.: PCT/EP2016/055542

§ 371 Date: Oct. 19, 2017

(30) Foreign Application Priority Data
Apr. 23, 2015 (DE) 10 2015 207 467.6

(51) Int. Cl. H02K 1/12; H02K 3/46; H02K 9/00; H02K 1/22

(52) U.S. Cl. CPC H02K 1/12; H02K 1/22; H02K 9/005; H02K 3/46

(57) ABSTRACT

An electrical machine comprising a rotor and a stator, wherein the rotor and/or the stator are designed to comprise a plurality of segments, each individual segment having one winding, respectively, wound around at least some sections thereof, each individual segment being surrounded, in the region of said winding by a casting material in at least some sections, and said casting material comprising, in the region of the winding, at least one axial depression in which at least one connecting element is arranged.

### CROSS-REFERENCE TO RELATED APPLICATIONS

This application is a National Stage of International Application No. PCT/EP2016/055542, filed Mar. 15, 2016, which claims priority to German Application No. 10 2015 207 467.6 filed Apr. 23, 2015. The entire disclosure of each of the above applications is incorporated herein by reference.

### FIELD OF THE INVENTION

The present invention relates to an electrical machine comprising a rotor and a stator, wherein the rotor and/or the stator are designed to comprise a plurality of segments.

### BACKGROUND

This section provides information related to the present disclosure which is not necessarily prior art.

Electrical machines, also described as electromechanical converters, convert electrical energy into mechanical energy (electric motors) and/or mechanical energy into electrical energy (generators). This electromechanical conversion is based upon electromagnetic induction.

According to a widespread design of an electrical machine, the rotor comprises a plurality of permanent magnets, and the stator comprises a plurality of stator windings (electromagnets), upon which one or more connector rings are arranged. An electrical machine of this type is described as a permanent magnet-excited synchronous machine (PSM). As a result of the moving magnetic field of the rotor, a current flux can be generated in the stator winding (generator), or a rotation of the rotor can be achieved by means of the magnetic field generated by the stator (electric motor).

An inverse form of construction, in which the stator comprises permanent magnets and the rotor comprises wire windings, is also known.

One alternative is the flux switching permanent magnet machine. This also comprises a stator, a rotor, permanent magnets and wire windings (electromagnets), but with all the components arranged on the stator. The stator is arranged coaxially to the rotor, and encloses the latter.

Electrical machines thus generally comprise a stationary stator, a movable rotor, permanent magnets and electromagnets. Both the rotor and the stator are generally of annular design, and are configured in a mutually coaxial arrangement, wherein the rotor is arranged to rotate around an axis of rotation, within or around the annular stator. The rotor and/or stator are generally formed of a plate stack and/or a plurality of plate stacks, and frequently comprise individual rotor and/or stator teeth, which are positioned on a rotor body and/or a stator body.

The connector rings assume the function of the mutual interconnection of the individual stator and/or rotor windings, and are generally arranged on the stator and/or rotor windings, on the overhang of said stator and/or rotor windings. The connector rings are generally accommodated in an annular switching element carrier, wherein the switching element carrier is connected to the rotor and/or the stator, for example by means of a clip-on connection.

In many cases, this arrangement is associated with a disadvantageous increase in the height of the rotor and/or of the stator, with a resulting increase in spatial requirements in the vertical direction.

Document DE 102011 108 042 A1 describes an exemplary stator, having stator windings, for an electrical machine, and a method for manufacturing a stator of this type for an electrical machine, wherein the stator (ring) is comprised of a plurality of individual tooth segments (with stator windings) which are at least partially enclosed in a casting compound, so as to form a stator body. Advantageously, a contact device, specifically a connector ring, is embedded in the casting compound in conjunction with the molding of the individual tooth segments. There are two options for this purpose: either the individual copper conductors (switching elements) of the connector rings are directly molded-in, i.e. the individual copper conductors are inserted in a mold such that, upon the casting of the casting compound, the copper conductors are bonded with the stator (windings), or the individual copper conductors are inserted in a housing (switching element carrier) and, in combination with the housing, are molded onto the stator windings by means of the casting compound.

In the first option, it is necessary for the copper conductors of the connector rings to be arranged within the mold such that, upon the casting of the casting compound, no positional alteration of the copper conductors occurs, thereby resulting, for example, in the unwanted mutual bonding of the individual copper conductors.

Moreover, the circuit interconnection in the first option has a fixed and irreversible configuration, and thus no clear space for the conduct of any maintenance and/or repair works.

The second option is again associated with the aforementioned undesirable increase in spatial requirements.

Document DE 10 2012 021 494 A1 discloses an electrical machine having a stator and a rotor, wherein the stator and/or rotor comprise windings and/or permanent magnets. Herein, the electrical machine, in the region of the windings and/or in the region of the connector rings, for the electrical interconnection of the windings and/or for the purposes of magnetic adhesion, incorporates an oil-repellent and water-repellent laminated structure. For the electrical insulation of the connector ring, the upper region of the winding overhang, and of the connector ring, are embedded in a casting compound, which is configured in the form of the laminated structure with an oil-repellent and water-repellent surface finish.

### SUMMARY OF THE INVENTION

This section provides a general summary of the disclosure, and is not a comprehensive disclosure of its full scope or all of its features.

One object of the invention is the disclosure of an electrical machine which, by an alternative configuration of the stator/rotor/switching element combination, can be manufactured in a cost-effective and optimum manner, specifically with respect to components and spatial requirements.

This object is fulfilled by an electrical machine comprising a rotor and a stator, wherein the rotor and/or the stator are designed to comprise a plurality of segments, each individual segment having one winding, respectively, wound around at least some sections thereof, each individual segment being surrounded, in the region of said winding, by a casting material in at least some sections, and said casting material comprising, in the region of the winding, at least one axial depression in which at least one connecting element is arranged.

According to the invention, the electrical machine comprises a rotor and a stator, wherein the rotor and/or the stator comprise a plurality of individual segments. The individual segments thus essentially constitute the rotor and/or the stator.

According to the invention, each individual segment of the stator and/or of the rotor has one winding, respectively, wound around at least some sections thereof and, in the region of the winding, is surrounded, at least in some sections, by a casting material.

The winding is preferably a wire winding.

According to the present invention, the casting material, in the region of the winding, incorporates at least one axial depression, wherein the function of said axial depression is the accommodation of connecting elements.

According to the present invention, the specific function of the connecting elements is the interconnection of the individual windings, wherein the connecting elements are preferably comprised of a conductive material.

However, a connecting element can also be understood to include any type of sensor component and/or electronic component.

By means of the configuration of the electrical machine according to the invention, it is possible to arrange at least one connecting element directly in an easily-accessible axial depression in the casting material which is configured for this purpose. It is thus possible to arrange the connecting element, with no connecting element carrier, in the overhang region of the individual windings, thereby saving space in the vertical direction. Moreover, by the configuration of the casting material and/or the axial depression in the region of the windings, a simple and reversible positioning of the switching elements is possible.

It is particularly advantageous if the casting material, in the region of the winding, incorporates a plurality of axial depressions, wherein at least one connecting element respectively is arranged in each of the axial depressions in the casting material.

It is moreover specifically preferred if each individual winding is provided with a contact device, wherein said contact device is not entirely enclosed in the casting compound such that, by means of the contact device, bonding of the respective winding with the respective connecting element can be achieved.

In a preferred form of embodiment of the present invention, the contact device is arranged in the region of the axial depression, or lies in one of the axial depressions.

In an overhead view, in the direction of the axis of rotation of the stator and/or rotor, the individual segments are preferably essentially configured with a T-shape, and are thus comprised of a perpendicular section and a horizontal section, wherein the respective winding is arranged around the perpendicular section of the T-shaped segment.

According to an advantageous configuration of the invention, the casting material is electrically insulating and thermally conductive.

Advantageously, the casting material is a plastic.

Further advantageously, the stator and/or rotor is configured with an essentially annular design.

In a particularly advantageous variant of embodiment of the present invention, the casting material incorporates at least one cooling duct and/or at least one cooling duct is configured in the casting material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a perspective view of one segment of a rotor and/or stator, with a winding.

FIG. 2 shows a perspective view of one segment of a rotor and/or stator, partially enclosed in casting material.

FIG. 3 shows a perspective view of one segment of a rotor and/or a stator, entirely enclosed in casting material.

FIG. 4 shows a further perspective view of a segment of a rotor and/or a stator, entirely enclosed in casting material.

FIG. 5 shows a sectional representation of the perspective view shown in FIG. 4.

FIG. 6 shows an overhead view of one segment of a rotor and/or a stator.

FIG. 7 shows a detailed sectional view of an overhang region (of the winding) of a segment of a rotor and/or a stator according to the invention.

### DETAILED DESCRIPTION OF THE INVENTION

Example embodiments will now be described more fully with reference to the accompanying drawings.

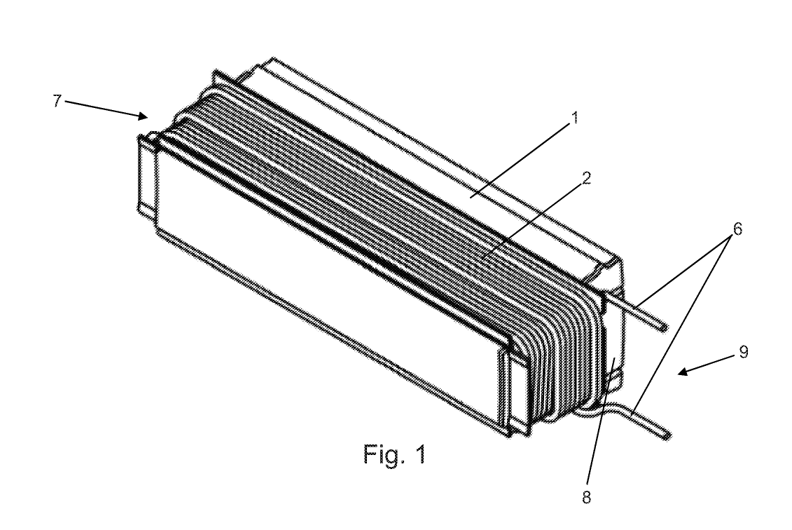

FIGS. 1 to 7 simply show different views of an individual segment 1 of a rotor and/or stator of an electrical machine according to the invention.

The electrical machine according to the invention comprises a rotor and a stator, wherein the rotor and/or the stator have a plurality of individual segments 1. The individual segments thus essentially constitute the rotor and/or stator.

FIG. 1 shows a section of the rotor and/or the stator, wherein a winding 2 is wound around some sections of the segment 1.

In an overhead view, in the direction of the axis of rotation of the stator and/or rotor, the segment 1 is essentially of a T-shaped design, and thus comprises a perpendicular section 7 and a horizontal section 8.

The winding 2 is configured around the perpendicular section 7 of the T-shaped segment 1.

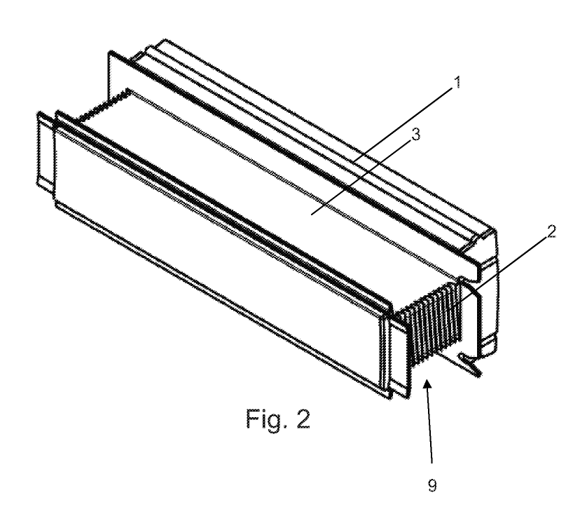

In the region of the winding 2, as can specifically be seen in FIG. 2, the segment 1 is enclosed in a casting material 3.

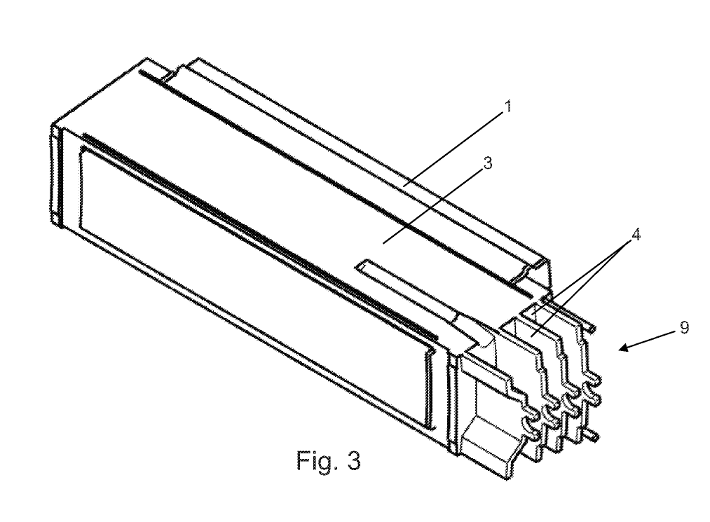

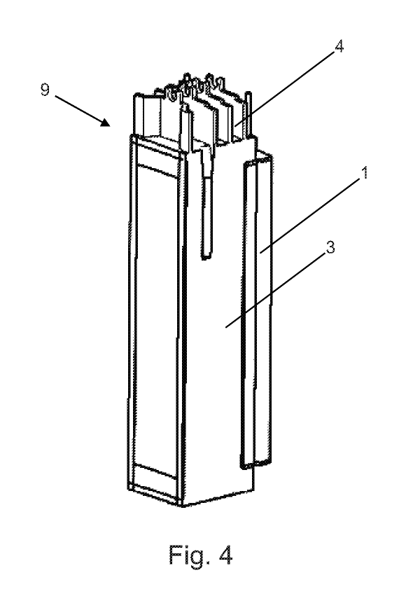

In FIG. 3 and FIG. 4, the winding 2 around the perpendicular section 7 of the segment 1 is entirely enclosed in the casting material 3.

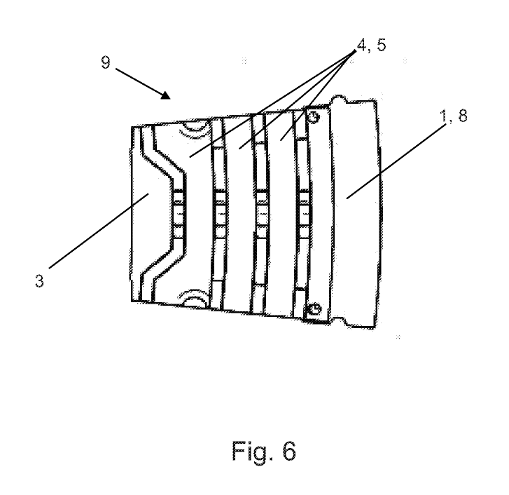

Moreover, in FIG. 3 and FIG. 4, in the region of the winding 2, specifically in the overhang region 9 of the winding 2, a number of axial depressions 4 configured in the casting material 3 are represented. These axial depressions 4 are intended for the accommodation of at least one connecting element 5 respectively (FIG. 6).

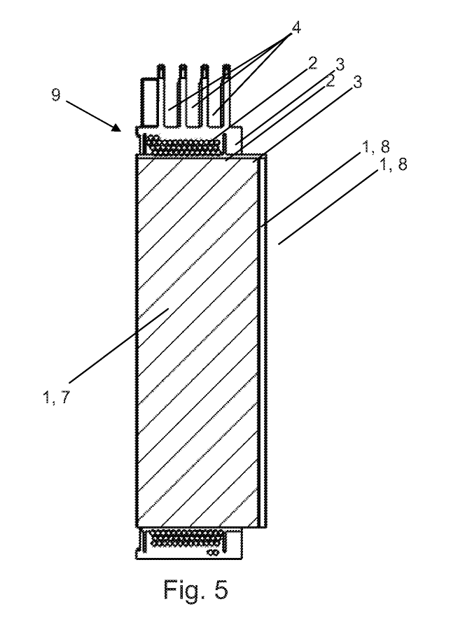

FIG. 5 shows a sectional view of the segment 1 of the rotor and/or stator represented in FIG. 3 and FIG. 4. Here again, the axial depressions 4 in the casting material 3, in the overhang region 9 of the winding 2, are clearly visible.

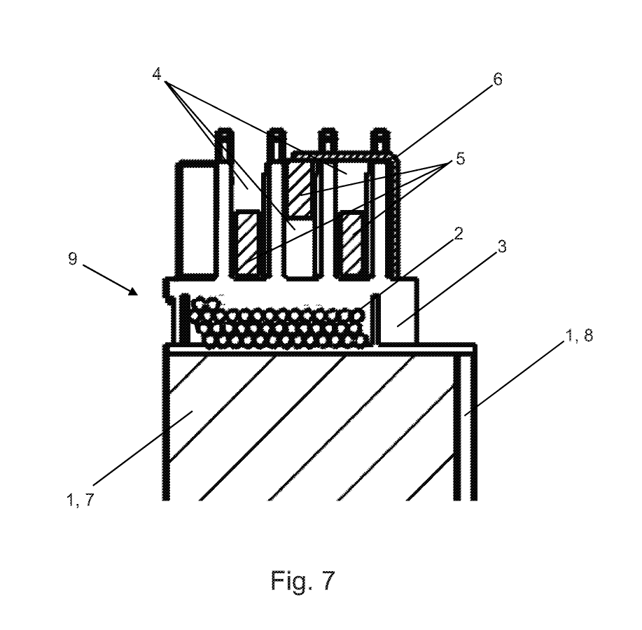

The winding 2 further incorporates a contact device 6 in the form of two wire terminations (FIG. 1, FIG. 7), wherein the contact device 6 is not entirely enclosed in the casting compound 3, such that, by means of (via the) contact device 6, bonding of the winding 2 with the respective connecting element 5 can be achieved.

The contact device 6 is arranged in the region of the axial depression 4.

### LIST OF REFERENCE SYMBOLS

1 Segment (of a rotor and/or stator)

2 Winding

3 Casting material

4 Axial depression

5 Connecting element

6 Contact device

7 Perpendicular section (of segment)

8 Horizontal section (of segment)

9 Overhang region (of winding)

1. An electrical machine comprising a rotor and a stator, wherein the rotor and/or the stator are designed to comprise a plurality of segments, each individual segment having one winding, respectively, wound around at least some sections thereof, each individual segment being surrounded, in the region of said winding by a casting material in at least some sections, wherein the casting material comprises, in the region of the winding, at least one axial depression in which at least one connecting element is arranged.

2. The electrical machine as claimed in claim 1, wherein the casting material in the region of the winding incorporates a plurality of axial depressions, wherein at least one connecting element respectively is arranged in each axial depression.

3. The electrical machine as claimed in claim 1, wherein each individual winding is provided with a contact device wherein said contact device is not entirely enclosed in the casting compound such that, by means of the contact device bonding of the respective winding with the respective connecting element can be achieved.

4. The electrical machine as claimed in claim 3, wherein the contact device is arranged in the region of the axial depression or one of the axial depressions.

5. The electrical machine as claimed in claim 1, wherein, in an overhead view, in the direction of the axis of rotation of the stator and/or rotor, the individual segments are essentially configured with a T-shape, and are thus comprised of a perpendicular section and a horizontal section wherein the respective winding is arranged around the perpendicular section of the T-shaped segment.

6. The electrical machine as claimed in claim 1, wherein the casting material is electrically insulating.

7. The electrical machine as claimed in claim 1, wherein the casting material is thermally conductive.

8. The electrical machine as claimed in claim 1, wherein the casting material is a plastic.

9. The electrical machine as claimed in claim 1, wherein the stator and/or rotor are essentially of annular design.

10. The electrical machine as claimed in claim 1, wherein the casting material incorporates at least one cooling duct and/or at least one cooling duct is configured in the casting material.
